(19) United States
(12) Patent Application Publication
(10) Pub. No.: US 2026/0332517 A1
(43) Pub. Date: Oct. 22, 2026

(54) Enhancements to Multi-Access Steering, Switching, and Spitting in Communication Networks

(71) Applicant: Apple Inc., Cupertino, CA (US)

(72) Inventors: Vivek G. Gupta, San Jose, CA (US); Haijing Hu, Los Gatos, CA (US)

(21) Appl. No.: 19/465,616

(22) Filed: Jan. 30, 2026

Related U.S. Application Data
(60) Provisional application No. 63/756,028, filed on Feb. 7, 2025.

(51) Int. Cl. H04L 45/247; H04L 47/19

(52) U.S. Cl. CPC H04L 45/247; H04L 47/19

(57) ABSTRACT

Systems and methods are configured to perform operations comprising sending an indication of a set of parameter values associated with multi-access traffic steering, switching and splitting (ATSSS) functionality, the set of parameter values representing support for multi-path quick user datagram protocol internet connections (MPQUIC) for internet protocol traffic, for Ethernet traffic, or for both the internet protocol traffic and Ethernet traffic; and performing a communication using at least one of steering, switching, or splitting functionality between a cellular network and a non-cellular network using IP packets, Ethernet frames, or both the IP packets and the Ethernet frames.

### CROSS-REFERENCE TO RELATED APPLICATIONS

This application claims priority to and the benefit of U.S. Provisional Patent Application No. 63/756,208, filed Feb. 7, 2025, the entire contents of which is incorporated herein by reference.

### TECHNICAL FIELD

The present disclosure relates to wireless communications.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the European Telecommunications Standards Institute (ETSI) Third Generation Partnership Project (3GPP). The wireless communication networks facilitate mobile broadband service using technologies such as orthogonal frequency-division multiple access (OFDMA), multiple-input multiple output (MIMO), advanced channel coding, massive MIMO, beamforming, and/or other features.

The non-access stratum (NAS) includes a functional layer in the NR, LTE, Universal Mobile Telecommunications System (UMTS), and Global System for Mobile Communications (GSM) wireless telecom protocol stacks between the Core Network (CN) and User Equipment (UE). NAS manages the establishment of communication sessions and maintains continuous communications with a user equipment (UE) as it moves. Once the UE establishes a radio connection, the UE uses the radio connection to communicate with core nodes to coordinate service.

### BRIEF DESCRIPTION OF THE FIGURES

FIG. 1 illustrates an example wireless network, according to some implementations.

FIG. 2 illustrates an example UE model for ATSSS-LL steering functionalities.

FIGS. 3A-3B each illustrates an example process, according to some implementations.

FIG. 4 illustrates an example UE, according to some implementations.

FIG. 5 illustrates an example access node, according to some implementations.

### DETAILED DESCRIPTION

The QUIC (Quick User Datagram Protocol Internet Connections) is a transport protocol that can be used with 5G New Radio (NR) to improve the security and efficiency of mobile networks. Multi-path QUIC (MPQUIC) steering functionality is a feature that enables steering, switching, and splitting of traffic across access networks. For MPQUIC, a user equipment establishes a connection with a user plane function (UPF) and sends a connect request to the UPF. The UPF verifies the request and sends a response. The UE and UPF select access to send data based on the steering mode. MPQUIC steering functionality allows mobile devices to use multiple access networks simultaneously, such as 5G-NR and WI-FI. This enables data flows to have increased reliability, reduced delay, and aggregated bandwidth. MPQUIC steering functionality can be used for traffic steering, switching, and splitting across 3GPP and non-3GPP access. MPQUIC can also be used to steer, switch, and split non-UDP traffic, such as TCP, IP, and Ethernet traffic.

Multi-Access (MASSS) supports phase 4 of access traffic steering, switching and splitting (ATSSS_Ph4). ATSSS-Ph4 involves specifying how the MPQUIC steering functionality defined as a part of phase 3 of access traffic steering, switching and splitting (ATSSS-Ph3) and how it is extended to be able to steer, switch, and split the IP traffic and the Ethernet traffic.

This disclosure describes ATSSS capability negotiation to define steering functionalities and other updates based on CN signaling with support for backward compatibility. These enhancements enable support for multipath QUIC-IP (MPQUIC-IP) and multipath QUIC-Ethernet (MPQUIC-E) steering functionalities. The enhancements include definitions of UE capabilities for supporting the steering functionalities when using MPQUIC for proxying UDP, IP, and Ethernet packets as a hypertext transfer protocol (HTTP) datagram payload. The enhancements include updating the ATSSS rules to support the new steering functionalities when using MPQUIC for proxying IP and Ethernet packets as HTTP datagram payload and specifying the potential impacts of the new steering functionalities on the NAS signaling. The enhancements include defining the co-existence of MPQUIC-IP and MPQUIC-E steering functionalities with existing steering functionalities. The enhancements enable proxying IP and Ethernet packets as HTTP datagram payload in Npcf_SMPolicyControl service. The enhancements include updates to the N4 rules to support the new steering functionalities when using MPQUIC for proxying IP and Ethernet packets as HTTP datagram payload.

Generally, for ATSSS steering, information can be routed to one of multiple networks, such as 3GPP/cellular networks and Wi-Fi networks, based on a selection at a device. For ATSSS switching, a device can move traffic from a cellular network to a Wi-Fi network or from the WI-FI network to a cellular network. For ATSSS splitting, a device sends part of its traffic on a cellular network and part of its traffic over a WI-FI network (or both for redundancy).

To perform ATSSS functions, a UE receives a set of policies from a policy control function. The polices are sent to a session management function (SMF), which sends them to the UE through an access management function (AMF). The UE can send traffic over one or both of these accesses (cellular and/or WI-FI) based on the policies. The UE can send traffic based on multipath TCP, which is sending traffic at layer three or above, or the UE can send the traffic based on ATSSS lower layer rules, such as active standby rules. These rules enable the UE to switch access points if network performance deteriorates (e.g., high latency is experienced), to load balance, or for other reasons. Alternatively or additionally, the UE can send data using MPQUIC as indicated previously.

To add MPQUIC-E and MPQUIC-IP functionality, the ATSSS functionalities are enhanced to define how data in HTTP packets, such as UDP packets, IP packets, or ethernet frames, are handled by the UPF when sent from a UE for steering, switching, and/or splitting functions in uplink contexts. These rules include coexistence rules to enable backward compatibility. Additionally, the policy rules can be applied by the UPF when traffic is sent from the network in downlink contexts.

For a multi-access PDU for ATSSS, the UE registers with each of the cellular network (e.g., 3GPP network) and another network such as a WI-FI network. The UE provides a same global unique temporary identifier (GUTI) when registering with each network. The UE establishes the PDU session over these two access points. If both access are in the same public land mobile network (PLMN), the UE can send multi access PDUs, session establishment request or any of the two accesses. If the two access points are in different PLMNs, the UE sends the request over one access. Once the UE receives a PDU session identifier (ID), the UE sends the same PDU session ID and registers, creating a PDU session for the second access. For steering, the UE can apply low layer steering functionality which operates below the IP layer. The ATSSS lower layer rules indicate how to split, switch, or steer the traffic in a manner different from MP-TCP and QUIC, which are high layer protocols.

This disclosure describes processes and devices that enable MPQUIC for ATSSS functionality for each of Ethernet and IP traffic. An information element (IE) that defines ATSSS steering capability is enhanced. This IE includes bits that indicate the 5GSM capability of ATSSS steering functionalities and steering modes and is subsequently described in further detail. The IEs described herein enable an ATSSS-capable UE to indicate its capabilities for supporting the steering functionalities when using MPQUIC for proxying UDP, IP, and Ethernet packets as HTTP datagram. The new functionality can co-exist with other steering functionality. Also the ATSSS, PCC and N4 rules can be pre-provisioned in the UE.

For MPQUIC-E and MPQUIC-IP, the network defines ATSSS policies that enable each of splitting, switching, and steering between cellular 3GPPP networks and other networks using Ethernet or IP traffic. The ATSSS policies enable UEs to perform MPQUIC-E and MPQUIC-IP on updated networks while preserving backwards compatibility with legacy networks. The network SMF receives a value in the ATSSS IE that indicates steering/switching/splitting functionality during establishment of a PDU session. The PDU session type and data network name (DNN) configuration indicate a protocol being used (ethernet, IP version, etc.) for the traffic and network name being used, which can determine the ATSSS functionality. This disclosure describes how to handle ethernet frames and IP packets in the HTTP data to support ATSSS functionalities for different PDU session types and DNN configurations.

The MPQUIC-E and MPQUIC-IP are supported in a backwards compatible way with the ATSSS lower layer functionality. The ATSSS allows for active standby mode to be used if nothing else is commonly supported between the UE and network. The UE can indicate to the network what ATSSS functionalities are supported, and the network can also indicate its supported functionality back to the UE. For backward compatibility, the UE can perform ATSSS even when the network does not indicate its capability. The UE can assume that the network may not support higher layer ATSSS functionality while attempting higher layer ATSSS for MPQUIC-E and MPQUIC-IP. The UE can fall back to an active standby mode if the higher layer ATSSS functionality is not supported by the network.

This disclosure also describes how values in the ATSSS IE can be enhanced to indicate higher layer ATSSS functionality without using reserved bits from the legacy ATSSS IE. This is because use of the reserved bits in the legacy ATSSS would cause the network to assume that there is an error in the received ATSSS IE. The enhanced ATSSS IE is configured to use new bits to indicate new functions to avoid this issue, as subsequently described. In this way, the ATSSS capability can be signaled in an enhanced manner without causing errors in legacy systems.

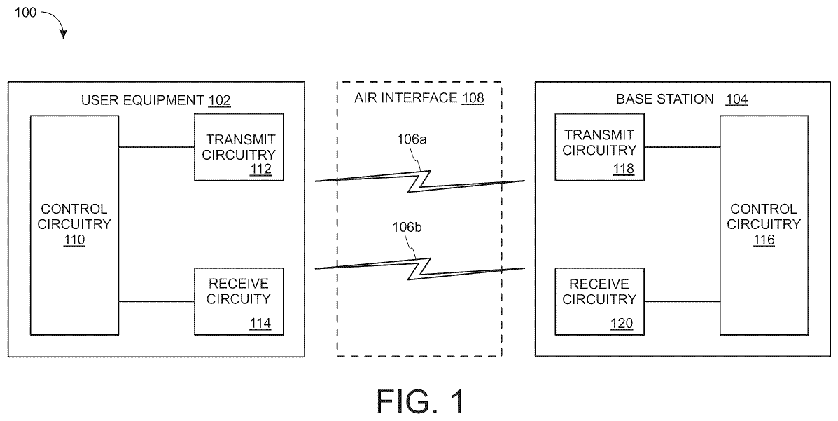

FIG. 1 illustrates an example wireless network 100, according to some implementations. The wireless network 100 includes a UE 102 and a base station 104, which are connected via one or more channels 106A, 106B across an air interface 108. The UE 102 and base station 104 communicate using a system that supports controls for managing the access of the UE 102 to a network via the base station 104.

In some implementations, the wireless network 100 is a standalone (SA) network, e.g., that incorporates fifth generation (5G) New Radio (NR). In some other implementations, the wireless network 100 is a non-standalone (NSA) network that incorporates Long Term Evolution (LTE) and 5G NR. In these implementations, the wireless network 100 may be an Evolved Universal Terrestrial Radio Access (E-UTRA) NR dual connectivity (EN-DC) network, or an NR-EUTRA dual connectivity (NE-DC) network. Furthermore, wireless networks implementing one or more other types of communication standards are possible, including future 3GPP systems (e.g., sixth generation “6G”), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In the wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For example, the control circuitry 110 can determine one or more slots to monitor for repetitions of a Type-0 PDCCH transmission that schedules a PDSCH transmission carrying SIB1. As described herein, the term “slot” refers to a time interval comprising 14 orthogonal frequency division multiplexing (OFDM) symbols.

The transmit circuitry 112 can perform various operations described herein. For example, the transmit circuitry 112 can transmit an indication of whether the UE 102 supports intra-slot repetition of Type-0 PDCCH and/or PDSCH with SIB1. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation (CA). The transmit circuitry 112 may be configured to receive block data from the control circuitry 110 for transmission on the air interface 108.

The receive circuitry 114 can perform various operations described herein. For example, the receive circuitry 114 can receive control signaling that configures one or more parameters for Type-0 PDCCH repetition and/or PDSCH repetition. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with CA. The transmit circuitry 112 and the receive circuitry 114 may transmit and receive, respectively, both control data and content data (e.g., messages, images, video, and the like) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink interface and may include one or more logical channels, including but not limited to a physical sidelink control channel (PSCCH), a physical sidelink discovery channel (PSDCH), and a physical sidelink broadcast channel (PSBCH).

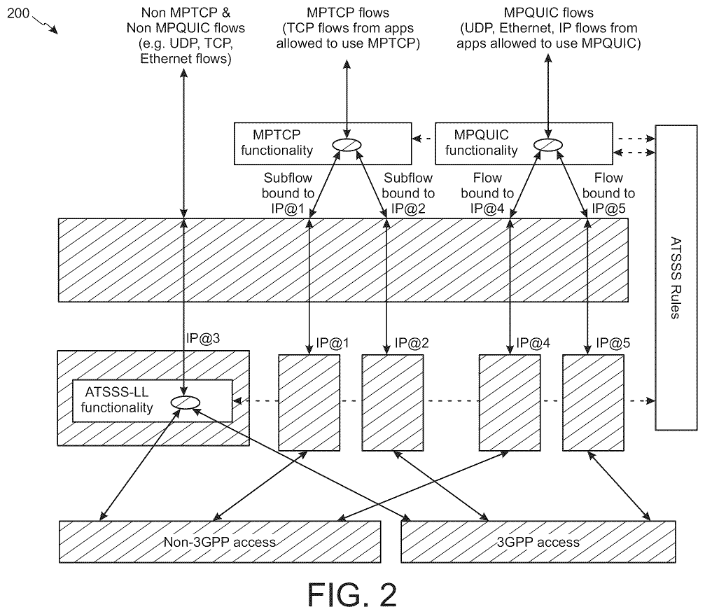

FIG. 2 shows an example of a UE model 200 that supports ATSSS lower layer (ATSSS-LL) functionalities and that can support additional ATSSS functionalities such as MPQUIC-IP and MPQUIC-E as previously described. The UE model 200 can support steering functionalities for IP and Ethernet proxying using MPQUIC. MPQUIC-based steering functionalities are supported as follows. MPQUIC-based functionalities enable steering, switching, and splitting of data traffic between the UE and UPF, in accordance with the ATSSS policy created by the network. The operation of the MPQUIC-UDP functionality is based on RFC 9298 “proxying UDP in HTTP”, which specifies how UDP traffic can be transferred between a client (UE) and a proxy (UPF) using the RFC 9114 HTTP/3 protocol. The MPQUIC-UDP functionality may be enabled for an MA PDU Session with type IPV4, IPV6 or IPv4v6, when both the UE and the network support this functionality. The MPQUIC-UDP functionality shall not be enabled when the type of the MA PDU Session is Ethernet. The operation of the MPQUIC-IP functionality is based on RFC 9484 “Proxying IP in HTTP”, which specifies how IP traffic can be transferred between a client (UE) and a proxy (UPF) using the RFC 9114 HTTP/3 protocol. The MPQUIC-IP functionality may be enabled for a MA PDU Session with type IPV4, IPv6 or IPv4v6, when both the UE and the network support this functionality. The MPQUIC-IP functionality is not enabled when the type of the MA PDU Session is Ethernet. The operation of the MPQUIC-E functionality is based on IETF draft-ietf-masque-connect-ethernet “Proxying Ethernet in HTTP”, which specifies how Ethernet traffic can be transferred between a client (UE) and a proxy (UPF) using the RFC 9114[171]HTTP/3 protocol. The MPQUIC-E functionality may be enabled when the type of the MA PDU Session is Ethernet. When MPQUIC-E functionality is enabled for an Ethernet type PDU Session, the SMF indicates PDU Session type as IP in the N2 information to NG-RAN.

An IE that indicates ATSSS capability is now described. Values indicate to the network which ATSSS functionalities are supported by a UE. In an example, value “0000” indicates that ATSSS not supported; value “0000” indicates that ATSSS Low-Layer functionality with any steering mode allowed for ATSSS lower layer (ATSSS-LL) is supported; value “0001” indicates that multi-path TCP (MPTCP) functionality with any steering mode and ATSSS-LL functionality with only active-standby steering mode is supported; value “0010” indicates that MPTCP functionality with any steering mode and ATSSS-LL functionality with any steering mode allowed for ATSSS-LL is supported; value “0011” indicates that MPTCP functionality with any steering mode and ATSSS-LL functionality with any steering mode allowed for ATSSS-LL is supported; value “0100” indicates that MPQUIC functionality with any steering mode and ATSSS-LL functionality with only active-standby steering mode is supported; value “0101” indicates that MPQUIC functionality with any steering mode and ATSSS-LL functionality with any steering mode allowed for ATSSS-LL is supported; value “0110” indicates that MPTCP functionality with any steering mode, MPQUIC functionality with any steering mode and ATSSS-LL functionality with only active-standby steering mode is supported; and value “0111” indicates that MPTCP functionality with any steering mode, MPQUIC functionality with any steering mode and ATSSS-LL functionality with any steering mode allowed for ATSSS-LL is supported. These ATSSS capabilities are redefined for the NAS protocol and new steering modes to work properly along with earlier ATSSS capabilities and steering modes, as previously described.

The supported ATSSS steering functionalities are restructured in a way that allows the UE to indicate the support of any combinations of the following capabilities: 1-ATSSS-LL functionality with any steering mode; 2-MPTCP functionality with any steering mode and ATSSS-LL with only Active-Standby steering mode; 3-MPQUIC-UDP functionality with any steering mode and ATSSS-LL with only Active-Standby steering mode; 4-MPQUIC-IP functionality with any steering mode and ATSSS-LL with only Active-Standby steering mode; and 5-MPQUIC-E functionality with any steering mode and ATSSS-LL with only Active-Standby steering model. In an aspect, if the network does not support or does not accept the indicated MPQUIC-E/MPQUIC-IP or the MPTCP steering functionalities, then the network can fallback to a minimum common functionality which is the ATSSS-LL with only Active-Standby steering mode. The option to fallback enables backward compatibility for ATSSS for existing or legacy networks that do except MPQUIC-IP ATSSS functionality.

The UE can indicate MPQUIC-IP functionality with any steering mode without any ATSSS-LL functionality. The UE indicates this capability when the UE supports only MPQUIC-IP functionality. As previously discussed, the ATSSS steering functionalities in the ATSSS-ST field in the 5GSM capability IE have unused values of the ATSSS-ST field, which are currently marked as “reserved.” Additional values representing capability to support ATSSS functionalities for MPQUIC-IP/MPQUIC-E, if added to the ATSSS-ST, cause legacy networks to drop the 5GSM capability IE, including all the parameters in it, as the network assumes an error has occurred. As such, an updated 5GSM capability IE is defined that allows the UE to signal support for MPQUIC-IP/MPQUIC-E without causing legacy networks to drop the IE. Several different options for the IE are described below.

In an aspect, a newly defined specific space (e.g., specific to Rel-18) is used to signal ATSSS capability. The IE can be defined using an extension flag to direct to the specific space and/or with a new IE.

An extension flag is used to indicate the ATSSS capability information for MPQUIC-IP and/or MPQUIC-E. The extension flag can be in the capabilities IE. The extension flag can indicate to a receiving entity that the ATSSS capability information is located in the IE (e.g., octets 4, or 5) or elsewhere. The flag is not limited to indication of any particular location. The 5GSM capability IE may be extended to having up to 15 octets. The flag, when set, indicates to the receiver to ignore a bit setting in the ATSSS-ST. This prevents clashing or conflicting indications that confuse the receiver. The extension flag points to a specific set of ATSSS capability bits. The extension flag is configured indicate whether additional ATSSS is or is not supported (e.g., in addition to ATSS lower layer functionality) rather than to indicate specific sharing modes. The specific support for ATSSS functionalities is indicated in other fields of an ATSSS capabilities IE.

In another example, the UE can indicate (to the network) any supported ATSSS functionalities for MPQUIC-E/MPQUIC-IP using a ATSSS capability IE that includes fields for indicating ATSSS-LL functionality and MPQUIC-IP, MPQUIC-E, MPQUIC-UDP, and MPTCP ATSSS functionalities. This IE is shown in Table 2. The ATSSS capability IE is defined with separate capability indications for the ATSSS-LL, MPTCP and each of the MPQUIC functionalities. The ATSSS capability IE replaces the ATSSS-ST field and uses the built-in backward compatibility mechanism of the NAS protocol. With this capability IE, the network determines whether the UE is a legacy or post legacy (e.g., a Rel-17 or a post-Rel-17) UE based on the presence of the IE. Additional ATSSS functionalities for MPQUIC-E/MPQUIC-IP can be added to the IE without impacting the existing parameters.

An example ATSSS IE for MPQUIC-E/MPQUIC-IP is shown below. The bits indicate the 5GSM capability of ATSSS steering functionalities and steering modes. In an example, value “0000” indicates that ATSSS is not supported; value “0001” indicates that ATSSS Low-Layer functionality with any steering mode allowed for ATSSS-LL is supported; value “0010” indicates that MPTCP functionality with any steering mode and ATSSS-LL functionality with only active-standby steering mode is supported; and value “0011” indicates that MPTCP functionality with any steering mode and ATSSS-LL functionality with any steering mode allowed for ATSSS-LL is supported. In this example, all other values are reserved. Example IEs are subsequently shown.

Table 1 shows an example of the 5GSM Capability IE. The purpose of the 5GSM capability information element is to indicate UE capability related to the PDU session management. The 5GSM capability is a type 4 information element with a minimum length of 3 octets and a maximum length of 15 octets.

TABLE 1
5GSM Capability IE

| 8 | 7 | 6 | 5 | 4 | 3 | 2 | 1 | |
|---|---|---|---|---|---|---|---|---|
| 5GSM capability IEI | | | | | | | | octet 1 |
| Length of 5GSM capability contents | | | | | | | | octet 2 |
| TPMIC | ATSSS-ST | | | | EPT-S1 | MH6- | RqoS | octet 3 |
| | | | | | | PDU | | |
| 0 Spare | 0 Spare | 0 Spare | 0 Spare | 0 Spare | 0 Spare | SDNA | APMQF | octet 4* |
| | | | | | | EPC | | |
| 0 | 0 | 0 | 0 | 0 | 0 | 0 | 0 | octet |

| | |
|---|---|
| Spare | 5*-15* |

The ATSSS capability IE specifies the particular ATSSS functionalities that are supported. Two bits (e.g., octet 3 bits 1-2) indicate ATSSS-LL functionality. This capability indicates the support for ATSSS-LL functionality as follows for bits 2-1: a value of “00” indicates that ATSSS-LL functionality is not supported; a value of “01” indicates that ATSSS-LL functionality with only active-standby steering mode is supported; a value of “10” indicates that ATSSS-LL functionality with any steering mode allowed for ATSSS-LL is supported; a value of “11” is a spare value.

Other values (e.g., bits of octet 3) indicate particular functionalities for ATSSS-LL. In an example, a value (e.g., octet 3, bit 3) represents whether there is support for MPTCP functionality with any steering mode (MPQUIC). For example, if the value is 0, MPTCP functionality with any steering mode is not supported. For example, if the value is 1, MPTCP functionality with any steering mode is supported. If ATSSS-LL-EXT is set to the value “00” then this bit shall be set to 0.

In an example, a value (e.g., octet 3, bit 4) represents whether there is support for MPQUIC-UDP functionality with any steering mode. For example, if the value is 0, MPQUIC-UDP functionality with any steering mode is not supported. For example, if the value is 1, MPQUIC-UDP functionality with any steering mode is supported. If ATSSS-LL-EXT is set to the value “00” then this bit shall be set to 0.

In an example, a value (e.g., octet 3, bit 5) represents whether there is support for MPQUIC-IP functionality with any steering mode. For example, if the value is 0, MPQUIC-IP functionality with any steering mode is not supported. For example, if the value is 1, MPQUIC-IP functionality with any steering mode is supported.

In an example, a value (e.g., octet 3, bit 6) represents whether there is support for MPQUIC-E functionality with any steering mode. For example, if the value is 0, MPQUIC-E functionality with any steering mode is not supported. For example, if the value is 1, MPQUIC-E functionality with any steering mode is supported. If ATSSS-LL-EXT is set to the value “00” then this bit shall be set to 0. In this example, all other bits in octet 3 to 15 are spare and shall be coded as zero, if the respective octet is included in the information element.

Table 2 shows an example of the ATSSS capability information element IE. The purpose of the ATSSS capability information element is to indicate UE capability related to the ATSSS. The ATSSS capability is a type 4 information element with a minimum length of 3 octets and a maximum length of 15 octets.

TABLE 2
Example ATSSS Capability IE

| | | | | | | | |
|---|---|---|---|---|---|---|---|
| 8 | 7 | 6 | 5 | 4 | 3 | 2 | 1 |

| ATSSS capability IEI | | | | | | | octet 1 |
|---|---|---|---|---|---|---|---|
| Length of ATSSS capability contents | | | | | | | octet 2 |
| 0 | 0 | MPQUIC- | MPQUIC- | MPQUIC- | MPTCP | ATSSS-LL- | octet 3 |
| Spare | Spare | E | IP | UDP | | EXT | |

| | |
|---|---|
| Spare | Octet 4*-15* |

Table 3 shows an example of the PDU session establishment request IE. The PDU session establishment request message is sent by the UE to the SMF to initiate establishment of a PDU session.

TABLE 3
Example ATSSS Capability IE

| | Information | Type/ | | | |
|---|---|---|---|---|---|
| IEI | Element | Reference | Presence | Format | Length |
| IE# | ATSSS | ATSSS | O | TLV | 3-15 |
| | capability | capability | | | |

In an another aspect, an ATSSS IE is defined in which ATSSS capability is indicated in bits that were previously spare bits in legacy networks. Table 4 shows the enhanced 5GSM IE with the ATSSS-ST field used for indication of ATSSS functionality. The values of the bits to indicate the 5GSM capability of ATSSS steering functionalities and steering modes as now described. A value of “0000” indicates that ATSSS is not supported. A value of “0001” indicates that ATSSS Low-Layer functionality with any steering mode allowed for ATSSS-LL is supported. A value of “0010” indicates that MPTCP functionality with any steering mode and ATSSS-LL functionality with only active-standby steering mode is supported. A value of “0011” indicates that MPTCP functionality with any steering mode and ATSSS-LL functionality with any steering mode allowed for ATSSS-LL is supported. In this example, all other IE values are reserved. In an example, the capability values are in the ATSSS-ST field of octet 3, shown in Table 4.

TABLE 4
Example 5GSM capability information element

| 8 | 7 | 6 | 5 | 4 | 3 | 2 | 1 | |
|---|---|---|---|---|---|---|---|---|
| 5GSM capability IEI | | | | | | | | octet |
| | | | | | | | | 1 |
| Length of 5GSM capability contents | | | | | | | | octet |
| | | | | | | | | 2 |
| TPMIC | ATSSS-ST | | | | EPT-S1 | MH6- | RqoS | octet |
| | | | | | | PDU | | 3 |
| 0 Spare | 0 | MPQU | MPQUI | MPQUIC- | ATSSS- | SDNA | APMQF | octet |
| | Spare | IC-E | C-IP | UDP | LL-AS | EPC | | 4* |
| 0 | 0 | 0 | 0 | 0 | 0 | 0 | 0 | octet |

| | |
|---|---|
| Spare | 5*-15* |

The purpose of the 5GSM capability information element is to indicate UE capability related to the PDU session management. The 5GSM capability is a type 4 information element with a minimum length of 3 octets and a maximum length of 15 octets.

In this example IE, octet 4 indicates which specific ATSSS functionalities are supported, using formerly spare bits. In this example, a value (octet 4, bit 3) indicates support for ATSSS-LL functionality with only active-standby steering mode (ATSSS-LL-AS). When the value is 0, ATSSS-LL functionality with only active-standby steering mode is not supported. When the value is 1, ATSSS-LL functionality with only active-standby steering mode is supported. The ATSSS-LL-AS bit is checked by the network only when the ATSSS-ST field is set to “ATSSS not supported” and: a) the MPQUIC-UDP bit is set to “MPQUIC-UDP functionality with any steering mode supported”; b) the MPQUIC-IP bit is set to “MPQUIC-IP functionality with any steering mode supported”; c) the MPQUIC-E bit is set to “MPQUIC-E functionality with any steering mode supported”; or d) any combination of a), b), and c).

In this example IE, a value (e.g., octet 4, bit 4) indicates support for MPQUIC-UDP functionality with any steering mode. When the value is 0, MPQUIC-UDP functionality with only with any steering mode is not supported. When the value is 1, MPQUIC-UDP functionality with any steering mode is supported. In this example IE, a value (octet 4, bit 5) indicates support for MPQUIC-IP functionality with any steering mode. When the value is 0, MPQUIC-IP functionality with only with any steering mode is not supported. When the value is 1, MPQUIC-IP functionality with any steering mode is supported. In this example IE, a value (octet 4, bit 6) indicates support for MPQUIC-E functionality with any steering mode. When the value is 0, MPQUIC-E functionality with only with any steering mode is not supported. When the value is 1, MPQUIC-E functionality with any steering mode is supported. In this example IE, all other bits in octet 4 to 15 are spare and shall be coded as zero if the respective octet is included in the information element.

The additional definitions for MPQUIC-UP, MPQUIC-UDP, and MPQUIC-IP are added in addition to values in the IE indicating ATSSS-LL functionalities. Legacy devices can still use the ATSSS-LL field while other devices an access the additional values for MPQUIC-UP, MPQUIC-UDP, and MPQUIC-IP to determine whether ATSSS functionalizes are supported for Ethernet, UDP, or IP traffic. The device can then connect using IP, or Ethernet and use MPQUIC and embed packets to tunnel using either the IP or Ethernet protocol.

UE-requested PDU session establishment procedure initiation is now described. When the UE requests to establish a new MA PDU session or if the UE requests to establish a new PDU session and the UE allows the network to upgrade the requested PDU session to an MA PDU session, if the UE has not set the ATSSS-ST bits to “ATSSS not supported” in the 5GSM capability IE of the PDU session establishment request message and the UE additionally supports: 1) MPQUIC-UDP functionality with any steering mode as specified in subclause 5.32.6 of 3GPP TS 23.501, the UE shall set the MPQUIC-UDP bit to “MPQUIC-UDP functionality with any steering mode supported”; 2) MPQUIC-IP functionality with any steering mode as specified in subclause 5.32.6 of 3GPP TS 23.501, the UE shall set the MPQUIC-IP bit to “MPQUIC-IP functionality with any steering mode supported”; and 3) MPQUIC-E functionality with any steering mode as specified in subclause 5.32.6 of 3GPP TS 23.501, the UE shall set the MPQUIC-E bit to “MPQUIC-E functionality with any steering mode supported”; in the 5GSM capability IE of the PDU session establishment request message. The value of the ATSSS-LL-AS bit in the 5GSM capability IE can be ignored here because the support of ATSSS-LL functionality can be obtained from the selected value inside the ATSSS-ST field.

Alternatively, when the UE requests to establish a new MA PDU session or if the UE requests to establish a new PDU session and the UE allows the network to upgrade the requested PDU session to an MA PDU session, and if the UE has set the ATSSS-ST bits to “ATSSS not supported” in the 5GSM capability IE of the PDU session establishment request message and the UE supports: 1) MPQUIC-UDP functionality with any steering mode and ATSSS-LL functionality with only active-standby steering mode as specified in subclause 5.32.6 of 3GPP TS 23.501, the UE shall set the MPQUIC-UDP bit to “MPQUIC-UDP functionality with any steering mode supported” and the ATSSS-LL-AS bit to “ATSSS-LL functionality with only active-standby steering mode supported”; 2) MPQUIC-IP functionality with any steering mode and ATSSS-LL functionality with only active-standby steering mode as specified in subclause 5.32.6 of 3GPP TS 23.501, the UE shall set the MPQUIC-IP bit to “MPQUIC-IP functionality with any steering mode supported” and the ATSSS-LL-AS bit to “ATSSS-LL functionality with only active-standby steering mode supported”; 3) MPQUIC-IP functionality with any steering mode without any ATSSS-LL functionality as specified in subclause 5.32.6 of 3GPP TS 23.501 and the PDU session type is not set to “Ethernet”, the UE shall set the MPQUIC-IP bit to “MPQUIC-IP functionality with any steering mode supported” and the ATSSS-LL-AS bit to “ATSSS-LL functionality with only active-standby steering mode not supported”; and 4) MPQUIC-E functionality with any steering mode and ATSSS-LL functionality with only active-standby steering mode as specified in subclause 5.32.6 of 3GPP TS 23.501, the UE shall set the MPQUIC-E bit to “MPQUIC-E functionality with any steering mode supported” and the ATSSS-LL-AS bit to “ATSSS-LL functionality with only active-standby steering mode supported”; in the 5GSM capability IE of the PDU session establishment request message.

UE-requested PDU session modification procedure initiation is now described. When the UE requests to establish a new MA PDU session or if the UE requests to establish a new PDU session and the UE allows the network to upgrade the requested PDU session to an MA PDU session, and: a) if the UE has not set the ATSSS-ST bits to “ATSSS not supported” in the 5GSM capability IE of the PDU SESSION ESTABLISHMENT REQUEST message and the UE additionally supports: 1) MPQUIC-UDP functionality with any steering mode as specified in subclause 5.32.6 of 3GPP TS 23.501, the UE shall set the MPQUIC-UDP bit to “MPQUIC-UDP functionality with any steering mode supported”; 2) MPQUIC-IP functionality with any steering mode as specified in subclause 5.32.6 of 3GPP TS 23.501, the UE shall set the MPQUIC-IP bit to “MPQUIC-IP functionality with any steering mode supported”; and 3) MPQUIC-E functionality with any steering mode as specified in subclause 5.32.6 of 3GPP TS 23.501, the UE shall set the MPQUIC-E bit to “MPQUIC-E functionality with any steering mode supported”; in the 5GSM capability IE of the PDU session establishment request message. The value of the ATSSS-LL-AS bit in the 5GSM capability IE can be ignored here because the support of ATSSS-LL functionality can be obtained from the selected value inside the ATSSS-ST field.

Alternatively, when the UE requests to establish a new MA PDU session or if the UE requests to establish a new PDU session and the UE allows the network to upgrade the requested PDU session to an MA PDU session, and b) if the UE has set the ATSSS-ST bits to “ATSSS not supported” in the 5GSM capability IE of the PDU SESSION ESTABLISHMENT REQUEST message and the UE supports: 1) MPQUIC-UDP functionality with any steering mode and ATSSS-LL functionality with only active-standby steering mode as specified in subclause 5.32.6 of 3GPP TS 23.501, the UE shall set the MPQUIC-UDP bit to “MPQUIC-UDP functionality with any steering mode supported” and the ATSSS-LL-AS bit to “ATSSS-LL functionality with only active-standby steering mode supported”; 2) MPQUIC-IP functionality with any steering mode and ATSSS-LL functionality with only active-standby steering mode as specified in subclause 5.32.6 of 3GPP TS 23.501, the UE shall set the MPQUIC-IP bit to “MPQUIC-IP functionality with any steering mode supported” and the ATSSS-LL-AS bit to “ATSSS-LL functionality with only active-standby steering mode supported”; 3) MPQUIC-IP functionality with any steering mode without any ATSSS-LL functionality as specified in subclause 5.32.6 of 3GPP TS 23.501 and the PDU session type is not set to “Ethernet”, the UE shall set the MPQUIC-IP bit to “MPQUIC-IP functionality with any steering mode supported” and the ATSSS-LL-AS bit to “ATSSS-LL functionality with only active-standby steering mode not supported”; and 4) MPQUIC-E functionality with any steering mode and ATSSS-LL functionality with only active-standby steering mode as specified in subclause 5.32.6 of 3GPP TS 23.501, the UE shall set the MPQUIC-E bit to “MPQUIC-E functionality with any steering mode supported” and the ATSSS-LL-AS bit to “ATSSS-LL functionality with only active-standby steering mode supported”; in the 5GSM capability IE of the PDU session establishment request message.

Additionally, if the MPQUIC-UDP bit is set to “MPQUIC-UDP functionality with any steering mode supported” in the 5GSM capability IE of the PDU session modification REQUEST message and the DNN configuration allows for the MPQUIC-UDP functionality with any steering mode, the SMF shall ensure that the established PDU session has additionally the capability of MPQUIC-UDP with any steering mode in the downlink and the uplink; b) if the MPQUIC-IP bit is set to “MPQUIC-IP functionality with any steering mode supported” in the 5GSM capability IE of the PDU session modification request message and the DNN configuration allows for the MPQUIC-IP functionality with any steering mode, the SMF shall ensure that the established PDU session has additionally the capability of MPQUIC-IP with any steering mode in the downlink and the uplink; and c) if the MPQUIC-E bit is set to “MPQUIC-E functionality with any steering mode supported” in the 5GSM capability IE of the PDU session modification request message and the DNN configuration allows for the MPQUIC-E functionality with any steering mode, the SMF shall ensure that the established PDU session has additionally the capability of MPQUIC-E with any steering mode in the downlink and the uplink; B) the ATSSS-ST bits set to “ATSSS not supported” and: a) the MPQUIC-UDP bit set to “MPQUIC-UDP functionality with any steering mode supported” and the ATSSS-LL-AS bit set to “ATSSS-LL functionality with only active-standby steering mode supported”; b) the MPQUIC-IP bit set to “MPQUIC-IP functionality with any steering mode supported” and the ATSSS-LL-AS bit set to “ATSSS-LL functionality with only active-standby steering mode supported”; c) the MPQUIC-E bit set to “MPQUIC-E functionality with any steering mode supported” and the ATSSS-LL-AS bit set to “ATSSS-LL functionality with only active-standby steering mode supported”; or d) any combination of a), b) and c); and: a) if the DNN configuration allows for one or more of the indicated MPQUIC functionalities with any steering mode and ATSSS-LL functionality with any steering mode (i.e., any steering mode allowed for ATSSS-LL functionality) but does not allow RTT measurement without using PMF protocol, the SMF shall ensure that the established PDU session has the capability of the allowed MPQUIC functionality(ies) with any steering mode and ATSSS-LL with only active-standby steering mode, load balancing steering mode or priority based steering mode steering mode in the downlink and the allowed MPQUIC functionality(ies) with any steering mode and ATSSS-LL with only active-standby steering mode in the uplink; b) if the DNN configuration allows for one or more of the indicated MPQUIC functionalities with any steering mode and ATSSS-LL functionality with any steering mode (i.e., any steering mode allowed for ATSSS-LL functionality) and allows RTT measurement without using PMF protocol, the SMF shall ensure that the established PDU session has the capability of the allowed MPQUIC functionality(ies) with any steering mode and ATSSS-LL with any steering mode (i.e., any steering mode allowed for ATSSS-LL functionality) in the downlink and the allowed MPQUIC functionality(ies) with any steering mode and ATSSS-LL with only active-standby steering mode in the uplink; c) if the DNN configuration allows for one or more of the indicated MPQUIC functionalities with any steering mode and ATSSS-LL functionality with only active-standby steering mode, the SMF shall ensure that the established PDU session has the capability of the allowed MPQUIC functionality(ies) with any steering mode and ATSSS-LL with only active-standby steering mode in the downlink and the uplink; or d) if the DNN configuration does not allow for any of the indicated MPQUIC functionalities with any steering mode and allows at least for the ATSSS-LL functionality with only active-standby steering mode, the SMF shall ensure that the established PDU session has the capability of the ATSSS-LL with only active-standby steering mode in the downlink and the uplink; or C) the ATSSS-ST bits set to “ATSSS not supported”, and: 1) the MPQUIC-UDP bit set to “MPQUIC-UDP functionality with any steering mode not supported”; 2) the MPQUIC-E bit set to “MPQUIC-E functionality with any steering mode not supported”; 3) the ATSSS-LL-AS bit set to “ATSSS-LL functionality with only active-standby steering mode not supported”; and 4) the MPQUIC-IP bit set to “MPQUIC-IP functionality with any steering mode supported”; and if the DNN configuration allows for the MPQUIC-IP functionality with any steering mode, the SMF shall ensure that the established PDU session has the capability of MPQUIC-IP with any steering mode in the downlink and the uplink.

In an aspect, the MPQUIC-E and MPQUIC-IP capabilities can be indicated as standalone capabilities in a separate IE from the legacy ATSSS IE described previously. The IE can indicate tunneling capabilities over HTTP, such as IP tunneling and Ethernet tunneling for MPQUIC steering functionality. The standalone MPQUIC-E and MPQUIC-IP capabilities are assigned to the: protocol pseudo-header of the HTTP/3 request (e.g., connect-UPD, connect-IP, and connect-ethernet) for the MPQUIC steering functionality. This IE is flexible because it allows for adding MPQUIC-E and MPQUIC-IP capabilities with QUIC for other features than multi-access steering, switching, and splitting. Table 5 shows an example of the IE with standalone indication of MPQUIC-E and MPQUIC-IP capabilities.

TABLE 5
Example 5GSM Capabilities IE with standalone MPQUIC-E and MPQUIC-IP

| 8 | 7 | 6 | 5 | 4 | 3 | 2 | 1 | |
|---|---|---|---|---|---|---|---|---|
| 5GSM capability IEI | | | | | | | | octet |
| | | | | | | | | 1 |
| Length of 5GSM capability contents | | | | | | | | octet |
| | | | | | | | | 2 |
| TPMIC | ATSSS-ST | | | | EPT-S1 | MH6- | RqoS | octet |
| | | | | | | PDU | | 3 |
| 0 Spare | 0 | 0 | Connect- | Connect- | Connect- | SDNA | APMQF | octet |
| | Spare | Spare | ethernet | ip | udp | EPC | | 4* |
| 0 | 0 | 0 | 0 | 0 | 0 | 0 | 0 | octet |

| | |
|---|---|
| Spare | 5*-15* |

In the example IE, octet 3 indicates ATSSS steering functionalities and steering modes in the ATSSS-ST field. A value of “0000” indicates that ATSSS functionality is not supported; a value of “0001” indicates that ATSSS lower layer functionality with any steering mode allowed for ATSSS-LL is supported; a value of “0010” indicates that MPTCP functionality with any steering mode and ATSSS-LL functionality with only active-standby steering mode is supported; a value of “0011” indicates that MPTCP functionality with any steering mode and ATSSS-LL functionality with any steering mode allowed for ATSSS-LL is supported. In this example, all other values are reserved.

In this example IE, a value in octet 4 (e.g., bit 3) indicates support for UDP tunneling associated with a single HTTP stream (connect-UDP) according to IETF RFC 9298. A value of 0 can indicate that UDP tunnel associated with a single HTTP stream is not supported. A value of 1 can indicate that UDP tunnel associated with a single HTTP stream is supported. If MPQUIC functionality is supported while support for UDP tunnel, IP tunnel, and ethernet tunnel associated with a single HTTP stream is not indicated, the recipient shall assume that the UE supports UDP tunnel associated with a single HTTP stream.

In this example IE, a value in octet 4 (e.g., bit 4) indicates support for IP tunnel associated with a single HTTP stream (connect-ip) according to RFC IETF 9484. A value of 0 can indicate that IP tunnel associated with a single HTTP stream is not supported. A value of 1 can indicate that IP tunnel associated with a single HTTP stream is supported. If MPQUIC functionality is supported while support for UDP tunnel, IP tunnel, and ethernet tunnel associated with a single HTTP stream is not indicated, the recipient shall assume that the UE supports UDP tunnel associated with a single HTTP stream.

In this example IE, a value in octet 4 (e.g., bit 5) indicates support for Ethernet tunnel associated with a single HTTP stream (connect-ethernet) according to draft-ietf-masque-connect-ethernet. A value of 0 can indicate that Ethernet tunnel associated with a single HTTP stream is not supported. A value of 1 can indicate that Ethernet tunnel associated with a single HTTP stream is supported. If MPQUIC functionality is supported while support for UDP tunneling, IP tunneling, and ethernet tunneling associated with a single HTTP stream is not indicated, the recipient shall assume that the UE supports UDP tunnel associated with a single HTTP stream.

In this example IE, all other bits in octet 4 to 15 are spare and shall be coded as zero if the respective octet is included in the information element.

An example of UE-requested PDU session establishment procedure initiation is now described. If the UE requests to establish a new MA PDU session or if the UE requests to establish a new PDU session and the UE allows the network to upgrade the requested PDU session to an MA PDU session: e) if the UE supports MPQUIC functionality with any steering mode and ATSSS-LL functionality with only active-standby steering mode as specified in subclause 5.32.6 of 3GPP TS 23.501, the UE shall set the ATSSS-ST bits to “MPQUIC functionality with any steering mode and ATSSS-LL functionality with only active-standby steering mode supported” and: i) if the UE supports UDP tunneling associated with a single HTTP stream according to IETF RFC 9298, the UE shall set the connect-udp bit to “UDP tunnel associated with a single HTTP stream supported”; ii) if the UE supports IP tunneling associated with a single HTTP stream according to IETF RFC 9484, the UE shall set the connect-ip bit to “IP tunnel associated with a single HTTP stream supported”; and iii) if the UE supports Ethernet tunneling associated with a single HTTP stream according to draft-ietf-masque-connect-ethernet, the UE shall set the connect-ethernet bit to “Ethernet tunnel associated with a single HTTP stream supported”, in the 5GSM capability IE of the PDU session establishment request message.

In an aspect, f) if the UE supports MPQUIC functionality with any steering mode and ATSSS-LL functionality with any steering mode (e.g., any steering mode allowed for ATSSS-LL functionality) as specified in subclause 5.32.6 of 3GPP TS 23.501, the UE shall set the ATSSS-ST bits to “MPQUIC functionality with any steering mode and ATSSS-LL functionality with any steering mode allowed for ATSSS-LL supported” and: i) if the UE supports UDP tunneling associated with a single HTTP stream according to IETF RFC 9298 [41A], the UE shall set the connect-udp bit to “UDP tunnel associated with a single HTTP stream supported”; ii) if the UE supports IP tunneling associated with a single HTTP stream according to IETF RFC 9484, the UE shall set the connect-ip bit to “IP tunnel associated with a single HTTP stream supported”; and iii) if the UE supports Ethernet tunneling associated with a single HTTP stream according to draft-ietf-masque-connect-ethernet, the UE shall set the connect-ethernet bit to “Ethernet tunnel associated with a single HTTP stream supported”, in the 5GSM capability IE of the PDU session establishment request message.

The UE-requested PDU session modification procedure initiation is now described. In an aspect, 5) if the UE supports MPQUIC functionality with any steering mode and ATSSS-LL functionality with only active-standby steering mode as specified in subclause 5.32.6 of 3GPP TS 23.501, the UE shall set the ATSSS-ST bits to “MPQUIC functionality with any steering mode and ATSSS-LL functionality with only active-standby steering mode supported” and: i) if the UE supports UDP tunneling associated with a single HTTP stream according to IETF RFC 9298, the UE shall set the connect-udp bit to “UDP tunnel associated with a single HTTP stream supported”; ii) if the UE supports IP tunneling associated with a single HTTP stream according to IETF RFC 9484, the UE shall set the connect-ip bit to “IP tunnel associated with a single HTTP stream supported”; and iii) if the UE supports Ethernet tunneling associated with a single HTTP stream according to draft-ietf-masque-connect-ethernet, the UE shall set the connect-ethernet bit to “Ethernet tunnel associated with a single HTTP stream supported”, in the 5GSM capability IE of the PDU SESSION MODIFICATION REQUEST message; 6) if the UE supports MPQUIC functionality with any steering mode and ATSSS-LL functionality with any steering mode (i.e., any steering mode allowed for ATSSS-LL functionality) as specified in subclause 5.32.6 of 3GPP TS 23.501, the UE shall set the ATSSS-ST bits to “MPQUIC functionality with any steering mode and ATSSS-LL functionality with any steering mode allowed for ATSSS-LL supported” and: i) if the UE supports UDP tunneling associated with a single HTTP stream according to IETF RFC 9298, the UE shall set the connect-udp bit to “UDP tunnel associated with a single HTTP stream supported”; ii) if the UE supports IP tunneling associated with a single HTTP stream according to IETF RFC 9484, the UE shall set the connect-ip bit to “IP tunnel associated with a single HTTP stream supported”; and iii) if the UE supports Ethernet tunneling associated with a single HTTP stream according to draft-ietf-masque-connect-ethernet, the UE shall set the connect-ethernet bit to “Ethernet tunnel associated with a single HTTP stream supported”, in the 5GSM capability IE of the PDU session modification request message.

Example policy and charging control (PCC) rules for MPQUIC-IP and MPQUIC-E ATSSS functionalities are now described. For a MA PDU session of IP type, the MPQUIC-IP rules can be either bundled with ATSSS-LL with active standby steering mode or be supported without using ATSSS-LL with active standby. For IP type of MA PDU session, ATSSS-LL with active standby steering modes is supported and can be enabled together with MPQUIC-IP. The steering functionality is not changed for the “match all” traffic. For a MA PDU session of Ethernet type, ATSSS-LL with active standby steering modes are supported and either MPQUIC-E and ATSSS-LL is enabled for all flows in the same MA PDU Session. For an Ethernet MA PDU session, the steering functionality is set to either ATSSS-LL or MPQUIC-E for “match all” traffic.

In an aspect, the PCC provides a PCC rule for “match all” traffic, as follows. In a first example, if the MA PDU Session is capable of supporting MPQUIC-IP functionality, the PCF may provide a PCC rule for “match all” traffic that contains a “match all” SDF template, the lowest precedence, and the steering functionality set to “MPQUIC-IP”. In a second example, if the MA PDU Session is capable of supporting MPQUIC-E functionality, the PCF may provide a PCC rule for “match all” traffic that contains a “match all” SDF template, the lowest precedence, and the steering functionality set to “MPQUIC-E”. In a third example, if the MA PDU session is capable of supporting ATSSS-LL functionality with any steering mode, the PCF may provide a PCC rule for “match all” traffic that contains a “match all” SDF template, the lowest precedence, and the steering functionality set to “ATSSS-LL”. In a fourth example, if the MA PDU session is capable of supporting ATSSS-LL functionality with an active standby steering mode, the PCF may provide a PCC rule for “match all” traffic that contains a “match all” SDF template, the lowest precedence, and the steering functionality set to “ATSSS-LL” and the steering mode is set to “Active-Standby”.

Multi-access rule (MAR) handling for 5GC is now described. In a MAR, the policy control function (e.g., the SMF) instructs the UPF regarding which traffic steering functionality to use, including either MPTCP, ATSSS-LL, MPQUIC-UDP, MPQUIC-IP or MPQUIC-E, using the steering functionality IE. If a UE indicates that it supports MPQUIC based functionalities (such as MPQUIC-UDP, MPQUIC-IP and/or MPQUIC-E) and ATSSS-LL, and if the network determines to apply both MPQUIC functionality and ATSSS-LL functionality for the UE's PDU session, the policy control function provisions a separated downlink PDRs for MPQUIC traffic and for non-MPQUIC traffic. In some implementations, different MARs shall be provisioned and associated with the separate downlink PDRs. The steering functionality shall be set to ATSSS-LL for the MAR associated with the downlink PDR for non-MPQUIC traffic.

MPQUIC based functionalities are now described. In an aspect, the SMF instructs the UPF (PSA) to activate the MPQUIC-UDP, MPQUIC-IP and/or MPQUIC-E steering functionalities for a given MA-PDU session, if MPQUIC needs to be used for UDP, IP and/or Ethernet traffic flows respectively. The MPQUIC-UDP functionality and MPQUIC-IP functionality shall be applied for an IP MA PDU session. The MPQUIC-E steering functionality shall be applied for an Ethernet MA PDU session. The UPF (PSA) shall allocate resources for the requested MPQUIC steering functionalities (e.g., MPQUIC Proxy address, MPQUIC link-specific multipath IP addresses, etc.), and perform traffic steering, switching and splitting according to the instructions from the SMF. The “MPQUIC-UDP functionality” is referred to as “MPQUIC functionality” in previous releases that do not support the MPQUIC-IP functionality and the MPQUIC-E functionality.

An example of feature negotiation is now described. Example optional features in Table 6 are defined for the Npcf_SMPolicyControl application programming interface (API). The optional features are negotiated using the existing extensibility mechanism. When the EnATSSS_v3 feature is supported, the MPQUIC-E steering functionality is only applied to the Ethernet MA PDU session. When the EnATSSS_v3 feature is supported, the MPQUIC-UDP, MPQUIC-IP and MPTCP steering functionalities are only applied for IP MA PDU session.

TABLE 6
Optional Features for Feature Negotiation

| Feature | | |
|---|---|---|
| number | Feature Name | Description |
| 1 | TSC | This feature indicates support for traffic steering control in |
| | | the (S)Gi-LAN, steering the 5G-LAN type of services or |
| | | routing of the user traffic to a local Data Network |
| | | identified by the DNAI per AF request. If the NF service |
| | | consumer supports this feature, the PCF shall behave as |
| | | described in clause 4.2.6.2.6. |
| 2 | ResShare | This feature indicates the support of service data flows |
| | | that share resources. If the NF service consumer supports |
| | | this feature, the PCF shall behave as described in |
| | | clause 4.2.6.2.8. |
| 3 | 3GPP-PS-Data-Off | This feature indicates the support of 3GPP PS Data off |
| | | status change reporting. |
| 4 | ADC | This feature indicates the support of application detection |
| | | and control. |
| 5 | UMC | Indicates that the usage monitoring control is supported. |
| 6 | NetLoc | This feature indicates the support of the Access Network |
| | | Information Reporting for 5GS. |
| 7 | RAN-NAS-Cause | This feature indicates the support for the detailed release |
| | | cause code information from the access network. (NOTE) |
| 8 | ProvAFsignalFlow | This feature indicates support for the feature of IMS |
| | | Restoration as described in clause 4.2.3.17. If NF service |
| | | consumer supports this feature the PCF may provision AF |
| | | signalling IP flow information. |
| 9 | PCSCF-Restoration- | This feature indicates support of P-CSCF Restoration |
| | Enhancement | Enhancement. It is used for the NF service consumer to |
| | | indicate if it supports P-CSCF Restoration Enhancement. |
| 100 | EnATSSS_v3 | Indicates the support of ATSSS enhancements which |
| | | includes MPQUIC-IP and MPQUIC-E steering |
| | | functionalities. It requires the support of the EnATSSS_v2 |
| | | features. |

Table 7 shows a list of enumerated steering functionalities.

TABLE 7
Enumeration of Steering Functionalities

| Enumeration | | |
|---|---|---|
| value | Description | Applicability |
| MPTCP | Indicates that PCF authorizes the MPTCP functionality to | |
| | support traffic steering, switching and splitting. | |
| MPQUIC | Indicates that PCF authorizes the MPQUIC functionality | EnATSSS_v2 |
| | to support traffic steering, switching and splitting. | |
| ATSSS_LL | Indicates that PCF authorizes the ATSSS-LL functionality | |
| | to support traffic steering, switching and splitting. | |
| MPQUIC_IP | Indicates that PCF authorizes the MPQUIC-IP | EnATSSS_v3 |
| | functionality to support traffic steering, switching and | |
| | splitting. | |
| MPQUIC_E | Indicates that PCF authorizes the MPQUIC-E | EnATSSS_v3 |
| | functionality to support traffic steering, switching and | |
| | splitting. | |

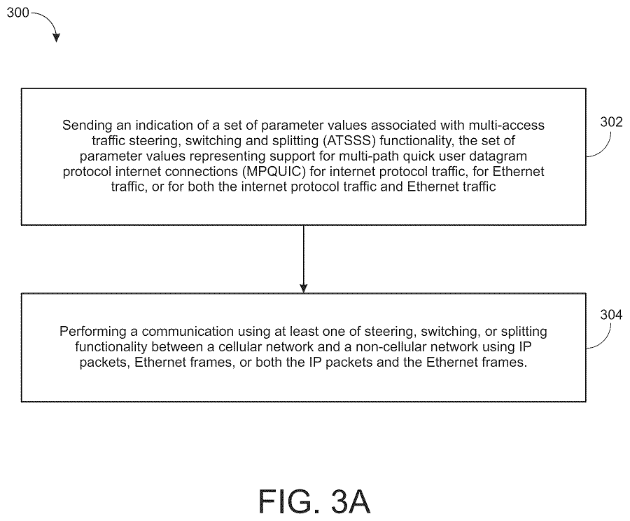

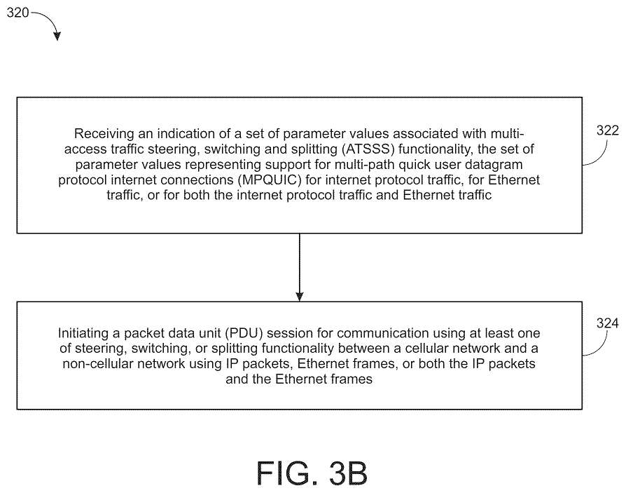

FIG. 3A illustrates a flowchart of an example method 300 for enhancements to multi-access steering, switching, and spitting in communication networks, according to some implementations. For clarity of presentation, the method 300 is described in the context of the preceding figures. For example, the method 300 can be performed by a UE (such as the UE 102 of FIG. 1), or any suitable system, environment, software, hardware, or combination thereof. In some implementations, operations of the method 300 can be run in parallel, in combination, in loops, or in any order. The example method 300 shown in FIG. 3A can be modified or reconfigured to include additional, fewer, or different steps (not shown in FIG. 3A), which can be performed in the order shown or in a different order.

The method 300 includes sending (302) an indication of a set of parameter values associated with multi-access traffic steering, switching and splitting (ATSSS) functionality, the set of parameter values representing support for multi-path quick user datagram protocol internet connections (MPQUIC) for internet protocol traffic, for Ethernet traffic, or for both the internet protocol traffic and Ethernet traffic. The method 300 includes performing (304) a communication using at least one of steering, switching, or splitting functionality between a cellular network and a non-cellular network using IP packets, Ethernet frames, or both the IP packets and the Ethernet frames.

In some implementations, the indication of the one or more parameters is sent to an access point of the cellular network and to an access point of the non-cellular network, with a global unique temporary identifier (GUTI) identifying a user equipment.

In some implementations, the indication indicates an active standby mode is supported as a fallback when the cellular network or the non-cellular network does not support ATSSS.

In some implementations, the set of parameter values further represents an indication of support for lower layer ATSSS (ATSSS-LL). In some implementations, the set of parameter values further represents an extension flag indicating support or not for non-ATSSS-LL. In some implementations, the indication for support of ATSSS-LL represents three modes of ATSSS support, wherein a first parameter value indicates that ATSSS-LL functionality is not supported, wherein a second parameter value indicates that ATSSS-LL functionality with only active-standby steering mode is supported, and wherein a third parameter value indicates that ATSSS-LL functionality with any steering mode allowed for ATSSS-LL is supported. In some implementations, a parameter of the set of parameter values represents support or not for multipath transmission control protocol (TCP) functionality with any steering mode. In some implementations, a parameter value of the set of parameter values represents support or not for MPQUIC user datagram protocol (UDP) functionality with any steering mode. In some implementations, a parameter value of the set of parameter values represents support or not for MPQUIC Ethernet functionality with any steering mode. In some implementations, a parameter value of the set of parameter values represents support or not for MPQUIC Internet protocol functionality with any steering mode.

In some implementations, the set of parameter values further represents an indication of support for ATSSS-LL functionality with only active-standby steering mode (ATSSS-LL-AS), and wherein the indication of the support for ATSSS-LL-AS functionality is configured to be checked when a first parameter indicates that ATSSS is not supported and when a second parameter indicates support for a MPQUIC functionality. In some implementations, the second parameter represents support or not for MPQUIC user datagram protocol (UDP) functionality with any steering mode. In some implementations, the second parameter represents support or not for MPQUIC Internet protocol functionality with any steering mode. In some implementations, the second parameter represents support or not for MPQUIC Ethernet functionality with any steering mode.

In some implementations, the set of parameter values represents an indication of support for tunnel capabilities over a hypertext transfer protocol (HTTP) payload for the IP packets or the Ethernet frames. In some implementations, the set of parameter values further represents an indication of support for ATSSS functionality, wherein a first parameter value indicates one of: that ATSSS functionality is not supported, that ATSSS lower layer functionality with any steering mode allowed for ATSSS-LL is supported, that MPTCP functionality with any steering mode and ATSSS-LL functionality with only active-standby steering mode is supported, or that MPTCP functionality with any steering mode and ATSSS-LL functionality with any steering mode allowed for ATSSS-LL is supported.

In some implementations, a first parameter value of the set of parameter values indicates support for UDP tunneling associated with a single HTTP stream (connect-UDP) according to IETF RFC 9298.

In some implementations, a first parameter value of the set of parameter values indicates support for IP tunnel associated with a single HTTP stream (connect-ip) according to IETF RFC 9484.

In some implementations, a first parameter value of the set of parameter values indicates support for Ethernet tunnel associated with a single HTTP stream (connect-ethernet) according to draft-ietf-masque-connect-ethernet.

In some implementations, the method 300 includes performing, for a multi-access rule, a traffic steering functionality selected from MPTCP, ATSSS-LL, MPQUIC-UDP, MPQUIC-IP or MPQUIC-E.

In some implementations, the method includes performing a communication in which MPQUIC functionality and ATSSS-LL functionality are applied for a packet data unit (PDU) session, wherein separate downlink packet detection rules are provisioned for MPQUIC traffic and for non-MPQUIC traffic.

In some implementations, the IP packets, Ethernet frames, or both the IP packets and the Ethernet frames are proxied by MPQUIC into a hypertext transfer protocol (HTTP) payload.

FIG. 3B illustrates a flowchart of an example method 320 for enhancements to multi-access steering, switching, and spitting in communication networks, according to some implementations. For clarity of presentation, the method 320 is described in the context of the preceding figures. For example, the method 300 can be performed by an access node (such as the base station 104 of FIG. 1), or any suitable system, environment, software, hardware, or combination thereof. In some implementations, operations of the method 320 can be run in parallel, in combination, in loops, or in any order. The example method 320 shown in FIG. 3B can be modified or reconfigured to include additional, fewer, or different steps (not shown in FIG. 3B), which can be performed in the order shown or in a different order.

The method 320 includes receiving (322) an indication of a set of parameter values associated with multi-access traffic steering, switching and splitting (ATSSS) functionality, the set of parameter values representing support for multi-path quick user datagram protocol internet connections (MPQUIC) for internet protocol traffic, for Ethernet traffic, or for both the internet protocol traffic and Ethernet traffic. The method includes initiating (324) a packet data unit (PDU) session for communication using at least one of steering, switching, or splitting functionality between a cellular network and a non-cellular network using IP packets, Ethernet frames, or both the IP packets and the Ethernet frames.

In some implementations, the indication of the one or more parameters is sent to an access point of the cellular network and to an access point of the non-cellular network, with a global unique temporary identifier (GUTI) identifying a user equipment.

In some implementations, the indication indicates an active standby mode is supported as a fallback when the cellular network or the non-cellular network does not support ATSSS.

In some implementations, the set of parameter values further represents an indication of support for lower layer ATSSS (ATSSS-LL). In some implementations, the set of parameter values further represents an extension flag indicating support or not for non-ATSSS-LL. In some implementations, the indication for support of ATSSS-LL represents three modes of ATSSS support, wherein a first parameter value indicates that ATSSS-LL functionality is not supported, wherein a second parameter value indicates that ATSSS-LL functionality with only active-standby steering mode is supported, and wherein a third parameter value indicates that ATSSS-LL functionality with any steering mode allowed for ATSSS-LL is supported. In some implementations, a parameter of the set of parameter values represents support or not for multipath transmission control protocol (TCP) functionality with any steering mode. In some implementations, a parameter value of the set of parameter values represents support or not for MPQUIC user datagram protocol (UDP) functionality with any steering mode. In some implementations, a parameter value of the set of parameter values represents support or not for MPQUIC Ethernet functionality with any steering mode. In some implementations, a parameter value of the set of parameter values represents support or not for MPQUIC Internet protocol functionality with any steering mode.

In some implementations, the set of parameter values further represents an indication of support for ATSSS-LL functionality with only active-standby steering mode (ATSSS-LL-AS), and wherein the indication of the support for ATSSS-LL-AS functionality is configured to be checked when a first parameter indicates that ATSSS is not supported and when a second parameter indicates support for a MPQUIC functionality. In some implementations, the second parameter represents support or not for MPQUIC user datagram protocol (UDP) functionality with any steering mode. In some implementations, the second parameter represents support or not for MPQUIC Internet protocol functionality with any steering mode. In some implementations, the second parameter represents support or not for MPQUIC Ethernet functionality with any steering mode.

In some implementations, the set of parameter values represents an indication of support for tunnel capabilities over a hypertext transfer protocol (HTTP) payload for the IP packets or the Ethernet frames. In some implementations, the set of parameter values further represents an indication of support for ATSSS functionality, wherein a first parameter value indicates one of: that ATSSS functionality is not supported, that ATSSS lower layer functionality with any steering mode allowed for ATSSS-LL is supported, that MPTCP functionality with any steering mode and ATSSS-LL functionality with only active-standby steering mode is supported, or that MPTCP functionality with any steering mode and ATSSS-LL functionality with any steering mode allowed for ATSSS-LL is supported.

In some implementations, a first parameter value of the set of parameter values indicates support for UDP tunneling associated with a single HTTP stream (connect-UDP) according to IETF RFC 9298.

In some implementations, a first parameter value of the set of parameter values indicates support for IP tunnel associated with a single HTTP stream (connect-ip) according to IETF RFC 9484.

In some implementations, a first parameter value of the set of parameter values indicates support for Ethernet tunnel associated with a single HTTP stream (connect-ethernet) according to draft-ietf-masque-connect-ethernet.

In some implementations, the method 320 includes performing, for a multi-access rule, a traffic steering functionality selected from MPTCP, ATSSS-LL, MPQUIC-UDP, MPQUIC-IP or MPQUIC-E.

In some implementations, the method 320 includes performing a communication in which MPQUIC functionality and ATSSS-LL functionality are applied for a packet data unit (PDU) session, wherein separate downlink packet detection rules are provisioned for MPQUIC traffic and for non-MPQUIC traffic.

In some implementations, the IP packets, Ethernet frames, or both the IP packets and the Ethernet frames are proxied by MPQUIC into a hypertext transfer protocol (HTTP) payload.

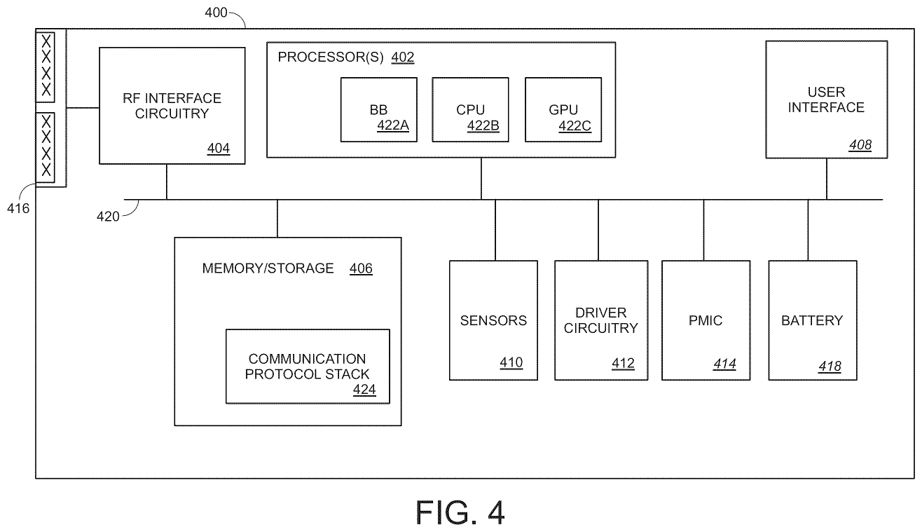

FIG. 4 illustrates an example UE 400, according to some implementations. The UE 400 may be similar to and substantially interchangeable with UE 102 of FIG. 1. The UE 400 may include any mobile or non-mobile computing device, such as, for example, a mobile phone, computer, tablet, industrial wireless sensors, video device (for example, cameras, video cameras, and the like), wearable devices (for example, a smart watch), relaxed internet-of-things (IOT) devices, etc.

The UE 400 may include any/all of processor 402, RF interface circuitry 404, memory/storage 406, user interface 408, sensors 410, driver circuitry 412, power management integrated circuit (PMIC) 414, one or more antenna(s) 416, and battery 418. The components of the UE 400 may be implemented as integrated circuits (ICs), portions thereof, discrete electronic devices, or other modules, logic, hardware, software, firmware, or a combination thereof. The block diagram of FIG. 4 is intended to show a high-level view of some of the components of the UE 400. However, some of the components shown may be omitted, additional components may be present, and a different arrangement of the components shown may occur in other implementations.

The components of the UE 400 may be coupled with various other components over one or more interconnects 420, which may represent any type of interface, input/output, bus (local, system, or expansion), transmission line, trace, or optical connection that allows various circuit components (on common or different chips or chipsets) to interact with one another.

The processor 402 may include one or more processors. For example, the processor 402 may include processor circuitry such as, for example, baseband (BB) processor circuitry 422A, central processor unit (CPU) circuitry 422B, and graphics processor unit (GPU) circuitry 422C. The processor 402 may include any type of circuitry or processor circuitry that executes or otherwise operates computer-executable instructions, such as program code, software modules, or functional processes from memory/storage 406 to cause the UE 400 to perform operations as described herein.

In some implementations, the baseband processor circuitry 422A may access a communication protocol stack 424 in the memory/storage 406 to communicate over a 3GPP compatible network. In general, the baseband processor circuitry 422A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and/or protocol data unit (PDU) layer; and perform control plane functions at a PHY layer, MAC layer, RLC layer, PDCP layer, RRC layer, and/or non-access stratum (NAS) layer. In some implementations, the PHY layer operations may additionally/alternatively be performed by components of the RF interface circuitry 404. The baseband processor circuitry 422A may generate or process baseband signals or waveforms that carry information in 3GPP-compatible networks. In some implementations, waveforms for NR may implement cyclic prefix-orthogonal frequency division multiplexing (CP-OFDM) in the uplink or downlink, and discrete Fourier transform-spread-orthogonal frequency division multiplexing (DFT-S-OFDM) in the uplink.

The memory/storage 406 may include one or more non-transitory, computer-readable media that includes instructions (for example, communication protocol stack 424) that can be executed by the processor 402 to cause the UE 400 to perform various operations described herein. The memory/storage 406 include any type of volatile or non-volatile memory that may be distributed throughout the UE 400. In some implementations, some of the memory/storage 406 may be located on the processor 402 itself (for example, Layer 1 “L1” and Layer 2 “L2” caches), while other memory/storage 406 is external to the processor 402 but accessible thereto via a memory interface. The memory/storage 406 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 404 may include transceiver circuitry and radio frequency front end module (RFEM) that allows the UE 400 to communicate with other devices over a radio access network. The RF interface circuitry 404 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 416 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 416. In various implementations, the RF interface circuitry 404 may be configured to transmit/receive signals in a manner compatible with NR access technologies.

The antenna(s) 416 may include one or more antenna elements to convert electrical signals into radio waves to travel through the air and to convert received radio waves over the air into electrical signals. In some implementations, the antenna elements may be arranged into one or more antenna panels. The antenna(s) 416 may have antenna panels that are omnidirectional, directional, or a combination thereof, to enable beamforming and multiple input, multiple output communications. The antenna(s) 416 may include any/all of microstrip antennas, printed antennas fabricated on the surface of one or more printed circuit boards, patch antennas, phased array antennas, etc. The antenna(s) 416 may have one or more panels designed for one or more specific frequency bands, such as bands in frequency range 1 (FR1) or frequency range 2 (FR2).

The user interface 408 includes various input/output (I/O) devices designed to enable user interaction with the UE 400. The user interface 408 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors), with the output of characters, graphics, multimedia objects, and the like being generated or produced from the operation of the UE 400.

The sensors 410 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 412 may include software and hardware elements that operate to control particular devices that are embedded in the UE 400, attached to the UE 400, or otherwise communicatively coupled with the UE 400. The driver circuitry 412 may include individual drivers allowing other components to interact with or control various I/O devices that may be present within, or connected to, the UE 400. For example, driver circuitry 412 may include a display driver to control and allow access to a display device, a touchscreen driver to control and allow access to a touchscreen interface, sensor drivers to obtain sensor readings of sensors 410 and control and allow access to sensors 410, drivers to obtain actuator positions of electro-mechanic components or control and allow access to the electro-mechanic components, a camera driver to control and allow access to an embedded image capture device, audio drivers to control and allow access to one or more audio devices.

The PMIC 414 may manage power provided to various components of the UE 400. In particular, with respect to the processor 402, the PMIC 414 may control power-source selection, voltage scaling, battery charging, or direct current (DC)-to-DC conversion.

In some implementations, the PMIC 414 may control, or otherwise be part of, various power saving mechanisms of the UE 400. A battery 418 may power the UE 400, although in some examples the UE 400 may be mounted deployed in a fixed location and may have a power supply coupled to an electrical grid. The battery 418 may be a lithium ion battery, a metal-air battery, such as a zinc-air battery, an aluminum-air battery, a lithium-air battery, and the like. In some implementations, such as in vehicle-based applications, the battery 418 may be a lead-acid automotive battery.

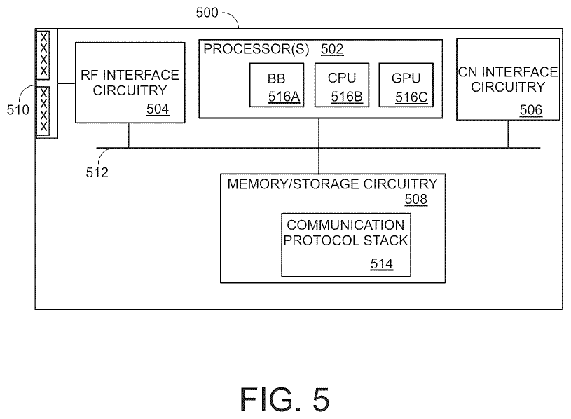

FIG. 5 illustrates an example access node 500 (e.g., a base station or gNB), according to some implementations. The access node 500 may be similar to and substantially interchangeable with base station 104. The access node 500 may include one or more of processor 502, RF interface circuitry 504, core network (CN) interface circuitry 506, memory/storage circuitry 508, and one or more antenna(s) 510. The processor 502 may include any type of circuitry or processor circuitry that executes or otherwise operates computer-executable instructions, such as program code, software modules, or functional processes from memory/storage circuitry 508 to cause the access node 500 to perform operations as described herein.

The components of the access node 500 may be coupled with various other components over one or more interconnects 512. The processor 502, RF interface circuitry 504, memory/storage circuitry 508 (including communication protocol stack 514), antenna(s) 510, and interconnects 512 may be similar to like-named elements shown and described with respect to FIG. 4. For example, the processor 502 may include processor circuitry such as, for example, BB processor circuitry 516A, CPU circuitry 516B, and GPU circuitry 516C.

The CN interface circuitry 506 may provide connectivity to a core network, for example, a 5G core (5GC) network using a 5GC-compatible network interface protocol such as carrier Ethernet protocols, or some other suitable protocol. Network connectivity may be provided to/from the access node 500 via a fiber optic or wireless backhaul. The CN interface circuitry 506 may include one or more dedicated processors or field-programmable gate arrays (FPGA) to communicate using one or more of the aforementioned protocols. In some implementations, the CN interface circuitry 506 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as base stations, gNBs, RAN nodes, eNBs, NodeBs, roadside units (RSU), transmit-receive points (TRP), and so forth, and can include ground stations (e.g., terrestrial access points) or satellite stations providing coverage within a geographic area (e.g., a cell). As used herein, the term “NG RAN node” or the like may refer to an access node 500 that operates in an NR or 5G system (for example, a gNB), and the term “E-UTRAN node” or the like may refer to an access node 500 that operates in an LTE or 4G system (e.g., an eNB). According to various implementations, the access node 500 may be implemented as one or more of a dedicated physical device such as a macrocell base station, and/or a low power base station for providing femtocells, picocells or other like cells having smaller coverage areas, smaller user capacity, or higher bandwidth compared to macrocells.

In some implementations, all or parts of the access node 500 may be implemented as one or more software entities running on server computers as part of a virtual network, which may be referred to as a cloud radio access network (CRAN) and/or a virtual baseband unit pool (vBBUP). In vehicle-to-everything (V2X) scenarios, the access node 500 may be or act as an RSU. The term RSU refers to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, or the like, as described above in connection with one or more of the preceding figures may be configured to operate in accordance with one or more of the examples set forth below.

### EXAMPLES

Example 1 is a method including sending an indication of a set of parameter values associated with multi-access traffic steering, switching and splitting (ATSSS) functionality, the set of parameter values representing support for multi-path quick user datagram protocol internet connections (MPQUIC) for internet protocol traffic, for Ethernet traffic, or for both the internet protocol traffic and Ethernet traffic; and performing a communication using at least one of steering, switching, or splitting functionality between a cellular network and a non-cellular network using IP packets, Ethernet frames, or both the IP packets and the Ethernet frames.

Example 2 includes the method of example 1, wherein the indication of the one or more parameters is sent to an access point of the cellular network and to an access point of the non-cellular network, with a global unique temporary identifier (GUTI) identifying a user equipment.

Example 3 includes the method of any of examples 1 to 2, wherein the indication indicates an active standby mode is supported as a fallback when the cellular network or the non-cellular network does not support ATSSS.

Example 4 includes the method of any of examples 1 to 3, wherein the set of parameter values further represents an indication of support for lower layer ATSSS (ATSSS-LL).

Example 5 includes the method of example 4, wherein the set of parameter values further represents an extension flag indicating support or not for non-ATSSS-LL.

Example 6 includes the method of example 4, wherein the indication for support of ATSSS-LL represents three modes of ATSSS support, wherein a first parameter value indicates that ATSSS-LL functionality is not supported, wherein a second parameter value indicates that ATSSS-LL functionality with only active-standby steering mode is supported, and wherein a third parameter value indicates that ATSSS-LL functionality with any steering mode allowed for ATSSS-LL is supported.

Example 7 includes the method of example 4, wherein a parameter of the set of parameter values represents support or not for multipath transmission control protocol (TCP) functionality with any steering mode.

Example 8 includes the method of example 4, wherein a parameter value of the set of parameter values represents support or not for MPQUIC user datagram protocol (UDP) functionality with any steering mode.

Example 9 includes the method of example 4, wherein a parameter value of the set of parameter values represents support or not for MPQUIC Ethernet functionality with any steering mode.

Example 10 includes the method of example 4, wherein a parameter value of the set of parameter values represents support or not for MPQUIC Internet protocol functionality with any steering mode.

Example 11 includes the method of any of examples 1 to 10, wherein the set of parameter values further represents an indication of support for ATSSS-LL functionality with only active-standby steering mode (ATSSS-LL-AS), and wherein the indication of the support for ATSSS-LL-AS functionality is configured to be checked when a first parameter indicates that ATSSS is not supported and when a second parameter indicates support for a MPQUIC functionality.

Example 12 includes the method of any of examples 1 to 11, wherein the second parameter represents support or not for MPQUIC user datagram protocol (UDP) functionality with any steering mode.

Example 13 includes the method of any of examples 1 to 12, wherein the second parameter represents support or not for MPQUIC Internet protocol functionality with any steering mode.

Example 14 includes the method of any of examples 1 to 13, wherein the second parameter represents support or not for MPQUIC Ethernet functionality with any steering mode.

Example 15 includes the method of any of examples 1 to 14, wherein the set of parameter values represents an indication of support for tunnel capabilities over a hypertext transfer protocol (HTTP) payload for the IP packets or the Ethernet frames.

Example 16 includes the method of example 15, wherein the set of parameter values further represents an indication of support for ATSSS functionality, wherein a first parameter value indicates one of: that ATSSS functionality is not supported, that ATSSS lower layer functionality with any steering mode allowed for ATSSS-LL is supported, that MPTCP functionality with any steering mode and ATSSS-LL functionality with only active-standby steering mode is supported, or that MPTCP functionality with any steering mode and ATSSS-LL functionality with any steering mode allowed for ATSSS-LL is supported.

Example 17 includes the method of any of examples 1 to 16, wherein a first parameter value of the set of parameter values indicates support for UDP tunneling associated with a single HTTP stream (connect-UDP) according to IETF RFC 9298.

Example 18 includes the method of any of examples 1 to 17, wherein a first parameter value of the set of parameter values indicates support for IP tunnel associated with a single HTTP stream (connect-ip) according to IETF RFC 9484.

Example 19 includes the method of any of examples 1 to 18, wherein a first parameter value of the set of parameter values indicates support for Ethernet tunnel associated with a single HTTP stream (connect-ethernet) according to draft-ietf-masque-connect-ethernet.

Example 20 includes the method of any of examples 1 to 19, further comprising performing, for a multi-access rule, a traffic steering functionality selected from MPTCP, ATSSS-LL, MPQUIC-UDP, MPQUIC-IP or MPQUIC-E.

Example 21 includes the method of any of examples 1 to 20, further comprising performing a communication in which MPQUIC functionality and ATSSS-LL functionality are applied for a packet data unit (PDU) session, wherein separate downlink packet detection rules are provisioned for MPQUIC traffic and for non-MPQUIC traffic.

Example 22 includes the method of any of examples 1 to 21, wherein the IP packets, Ethernet frames, or both the IP packets and the Ethernet frames are proxied by MPQUIC into a hypertext transfer protocol (HTTP) payload.

Example 23 includes a method comprising: receiving an indication of a set of parameter values associated with multi-access traffic steering, switching and splitting (ATSSS) functionality, the set of parameter values representing support for multi-path quick user datagram protocol internet connections (MPQUIC) for internet protocol traffic, for Ethernet traffic, or for both the internet protocol traffic and Ethernet traffic; and initiating a packet data unit (PDU) session for communication using at least one of steering, switching, or splitting functionality between a cellular network and a non-cellular network using IP packets, Ethernet frames, or both the IP packets and the Ethernet frames.

Example 24 includes the method of example 23, wherein the indication of the one or more parameters is sent to an access point of the cellular network and to an access point of the non-cellular network, with a global unique temporary identifier (GUTI) identifying a user equipment.

Example 25 includes the method any of examples 23 to 24, wherein the indication indicates an active standby mode is supported as a fallback when the cellular network or the non-cellular network does not support ATSSS.

Example 26 includes the method any of examples 23 to 25, wherein the set of parameter values further represents an indication of support for lower layer ATSSS (ATSSS-LL).

Example 27 includes the method of example 26, wherein the set of parameter values further represents an extension flag indicating support or not for non-ATSSS-LL.

Example 28 includes the method of example 26, wherein the indication for support of ATSSS-LL represents three modes of ATSSS support, wherein a first parameter value indicates that ATSSS-LL functionality is not supported, wherein a second parameter value indicates that ATSSS-LL functionality with only active-standby steering mode is supported, and wherein a third parameter value indicates that ATSSS-LL functionality with any steering mode allowed for ATSSS-LL is supported.

Example 29 includes the method of example 26, wherein a parameter of the set of parameter values represents support or not for multipath transmission control protocol (TCP) functionality with any steering mode.

Example 30 includes the method of example 26, wherein a parameter value of the set of parameter values represents support or not for MPQUIC user datagram protocol (UDP) functionality with any steering mode.

Example 31 includes the method of example 26, wherein a parameter value of the set of parameter values represents support or not for MPQUIC Ethernet functionality with any steering mode.

Example 32 includes the method any of example 26, wherein a parameter value of the set of parameter values represents support or not for MPQUIC Internet protocol functionality with any steering mode.

Example 33 includes the method any of examples 23 to 32, wherein the set of parameter values further represents an indication of support for ATSSS-LL functionality with only active-standby steering mode (ATSSS-LL-AS), and wherein the indication of the support for ATSSS-LL-AS functionality is configured to be checked when a first parameter indicates that ATSSS is not supported and when a second parameter indicates support for a MPQUIC functionality.

Example 34 includes the method of example 33, wherein the second parameter represents support or not for MPQUIC user datagram protocol (UDP) functionality with any steering mode.

Example 35 includes the method of example 33, wherein the second parameter represents support or not for MPQUIC Internet protocol functionality with any steering mode.

Example 36 includes the method of example 33, wherein the second parameter represents support or not for MPQUIC Ethernet functionality with any steering mode.

Example 37 includes the method any of examples 23 to 36, wherein the set of parameter values represents an indication of support for tunnel capabilities over a hypertext transfer protocol (HTTP) payload for the IP packets or the Ethernet frames.

Example 38 includes the method of example 37, wherein the set of parameter values further represents an indication of support for ATSSS functionality, wherein a first parameter value indicates one of: that ATSSS functionality is not supported, that ATSSS lower layer functionality with any steering mode allowed for ATSSS-LL is supported, that MPTCP functionality with any steering mode and ATSSS-LL functionality with only active-standby steering mode is supported, or that MPTCP functionality with any steering mode and ATSSS-LL functionality with any steering mode allowed for ATSSS-LL is supported.

Example 39 includes the method any of examples 23 to 38, wherein a first parameter value of the set of parameter values indicates support for UDP tunneling associated with a single HTTP stream (connect-UDP) according to IETF RFC 9298.

Example 40 includes the method any of examples 23 to 39, wherein a first parameter value of the set of parameter values indicates support for IP tunnel associated with a single HTTP stream (connect-ip) according to IETF RFC 9484.

Example 41 includes the method any of examples 23 to 40, wherein a first parameter value of the set of parameter values indicates support for Ethernet tunnel associated with a single HTTP stream (connect-ethernet) according to draft-ietf-masque-connect-ethernet.

Example 42 includes the method any of examples 23 to 41, further comprising performing, for a multi-access rule, a traffic steering functionality selected from MPTCP, ATSSS-LL, MPQUIC-UDP, MPQUIC-IP or MPQUIC-E.

Example 43 includes the method any of examples 23 to 42, further comprising performing a communication in which MPQUIC functionality and ATSSS-LL functionality are applied for a packet data unit (PDU) session, wherein separate downlink packet detection rules are provisioned for MPQUIC traffic and for non-MPQUIC traffic.

Example 44 includes the method any of examples 23 to 43, wherein the IP packets, Ethernet frames, or both the IP packets and the Ethernet frames are proxied by MPQUIC into a hypertext transfer protocol (HTTP) payload.

Example 45 includes a non-transitory computer storage medium encoded with instructions that, when executed by one or more computers, cause the one or more computers to perform the method of any of examples 1 to 44.

Example 46 includes a system comprising one or more processors and one or more storage devices on which are stored instructions that are operable, when executed by the one or more processors, to cause the one or more processors to perform the method of any of examples 1 to 44.

Example 47 includes an apparatus comprising one or more baseband processors configured to perform the method of any of examples 1 to 44.

Example 48 includes an access node comprising: one or more processors; and memory storing instructions that, when executed by the one or more processors, cause the base station to perform the method of any of examples 23-44.

Example 49 includes a user equipment comprising: one or more processors; and memory storing instructions that, when executed by the one or more processors, cause the base station to perform the method of any of examples 1-23.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method comprising:
sending a set of parameter values associated with multi-access traffic steering, switching and splitting (ATSSS) functionality, the set of parameter values representing support for multi-path quick user datagram protocol internet connections (MPQUIC) for internet protocol traffic, for Ethernet traffic, or for both the internet protocol traffic and Ethernet traffic; and
performing a communication using at least one of steering, switching, or splitting functionality between a cellular network and a non-cellular network using IP packets, Ethernet frames, or both the IP packets and the Ethernet frames.

2. The method of claim 1, wherein the set of parameter values is sent to an access point of the cellular network and to an access point of the non-cellular network, with a global unique temporary identifier (GUTI) identifying a user equipment.

3. The method of claim 1, wherein the set of parameter values indicates an active standby mode is supported as a fallback when the cellular network or the non-cellular network does not support ATSSS.

4. The method of claim 1, wherein the set of parameter values further represents an indication of support for lower layer ATSSS (ATSSS-LL); or
wherein the set of parameter values further represents an indication of support for ATSSS-LL functionality with only active-standby steering mode (ATSSS-LL-AS), and wherein the indication of the support for ATSSS-LL-AS functionality is configured to be checked when a first parameter indicates that ATSSS is not supported and when a second parameter indicates support for a MPQUIC functionality.

5. The method of claim 4, wherein the set of parameter values represents an extension flag indicating support or not for non-ATSSS-LL.

6. The method of claim 4, wherein the indication for support of ATSSS-LL represents three modes of ATSSS support,
wherein a first parameter value indicates that ATSSS-LL functionality is not supported,
wherein a second parameter value indicates that ATSSS-LL functionality with only active-standby steering mode is supported, and
wherein a third parameter value indicates that ATSSS-LL functionality with any steering mode allowed for ATSSS-LL is supported.

7. The method of claim 4, wherein a parameter of the set of parameter values represents support or not for multipath transmission control protocol (TCP) functionality with any steering mode.

8. The method of claim 4, wherein a parameter value of the set of parameter values represents support or not for MPQUIC user datagram protocol (UDP) functionality with any steering mode.

9. The method of claim 4, wherein a parameter value of the set of parameter values represents support or not for MPQUIC Ethernet functionality with any steering mode.

10. The method of claim 4, wherein a parameter value of the set of parameter values represents support or not for MPQUIC Internet protocol functionality with any steering mode.

11. The method of claim 1, wherein the set of parameter values represents an indication of support for tunnel capabilities over a hypertext transfer protocol (HTTP) payload for the IP packets or the Ethernet frames.

12. The method of claim 1, wherein the set of parameter values represents an indication of support for ATSSS functionality, wherein a first parameter value indicates one of:
that ATSSS functionality is not supported,
that ATSSS lower layer functionality with any steering mode allowed for ATSSS-LL is supported,
that MPTCP functionality with any steering mode and ATSSS-LL functionality with only active-standby steering mode is supported, or
that MPTCP functionality with any steering mode and ATSSS-LL functionality with any steering mode allowed for ATSSS-LL is supported.

13. The method of claim 1, further comprising performing, for a multi-access rule, a traffic steering functionality selected from MPTCP, ATSSS-LL, MPQUIC-UDP, MPQUIC-IP or MPQUIC-E.

14. An apparatus comprising:
a memory; and
one or more processors configured to execute instructions stored in the memory for wireless communication, the instructions configured to cause the one or more processors to perform operations comprising:
receiving a set of parameter values associated with multi-access traffic steering, switching and splitting (ATSSS) functionality, the set of parameter values representing support for multi-path quick user datagram protocol internet connections (MPQUIC) for internet protocol traffic, for Ethernet traffic, or for both the internet protocol traffic and Ethernet traffic; and
initiating a packet data unit (PDU) session for communication using at least one of steering, switching, or splitting functionality between a cellular network and a non-cellular network using IP packets, Ethernet frames, or both the IP packets and the Ethernet frames.

15. The apparatus of claim 14, wherein the set of parameter values is sent to an access point of the cellular network and to an access point of the non-cellular network, with a global unique temporary identifier (GUTI) identifying a user equipment.

16. The apparatus of claim 14, wherein the set of parameter values indicates an active standby mode is supported as a fallback when the cellular network or the non-cellular network does not support ATSSS.

17. The apparatus of claim 14, wherein the set of parameter values further represents an indication of support for lower layer ATSSS (ATSSS-LL).

18. The apparatus of claim 17, wherein the set of parameter values further represents an extension flag indicating support or not for non-ATSSS-LL.

19. The apparatus of claim 17, wherein the indication for support of ATSSS-LL represents three modes of ATSSS support,
wherein a first parameter value indicates that ATSSS-LL functionality is not supported,
wherein a second parameter value indicates that ATSSS-LL functionality with only active-standby steering mode is supported, and
wherein a third parameter value indicates that ATSSS-LL functionality with any steering mode allowed for ATSSS-LL is supported.

20. One or more processors configured to execute instructions stored in a memory for wireless communication, the instructions configured to cause the one or more processors to perform operations comprising:
sending a set of parameter values associated with multi-access traffic steering, switching and splitting (ATSSS) functionality, the set of parameter values representing support for multi-path quick user datagram protocol internet connections (MPQUIC) for internet protocol traffic, for Ethernet traffic, or for both the internet protocol traffic and Ethernet traffic; and
performing a communication using at least one of steering, switching, or splitting functionality between a cellular network and a non-cellular network using IP packets, Ethernet frames, or both the IP packets and the Ethernet frames.
